(19) United States
(12) Patent Application Publication
(10) Pub. No.: US 2006/0164571 A1
(43) Pub. Date: Jul. 27, 2006

(54) Polarizing arrangement

(75) Inventors: Dirk Jan Broer, Eindhoven (NL); Hendrik De Koning, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILLIPS ELECTRONICS N.C.

(21) Appl. No.: 10/530,448

(22) PCT Filed: Sep. 19, 2003
(86) PCT No.: PCT/IB03/04264

§ 371 Date: Apr. 6, 2005

(30) Foreign Application Priority Data
Oct. 14, 2002 (NL) 1021644

(51) Int. Cl. G02F 1/1335

(52) U.S. Cl. 349/98

(57) ABSTRACT

A polarizing arrangement comprises a first linear polarizer having a first extinction axis. The polarization contrast ratio of the first polarizer is dependent on the angle a light beam incident on the polarizer makes with the extinction axis, polarization being most efficient when the light beam is orthogonal to the first extinction axis. In order to improve the polarization contrast ratio, for light beams traveling in directions which make an angle with the first extinction axis of the first polarizer the polarizing arrangement comprises a second polarizer having a second extinction axis. The first and second polarizer are arranged relative to one another such that, in operation, a light beam traversing the first polarizer in a direction orthogonal to the first extinction axis traverses the second polarizer in a direction coincident with the second extinction axis. The second polarizer has a similar angular-dependent polarization contrast ratio which due the specific arrangement of the first extinction axis with respect to the second extinction axis compensates the reduction of polarization contrast ratio for the first polarizer for light beams which make an angle with the first extinction axis.

The invention relates to a polarizing arrangement for polarization-selectively transmitting linear-polarized light.

The invention also relates to a combination of a first and a second polarizer for use in such a polarizing arrangement.

The invention further relates to the use of an optically anisotropic body as a polarizer.

Components which polarization-selectively transmit linear polarized light, linear polarizers for short, are known in the art as such. A well-known example is a dichroic polarizer comprising a stretched poly(co-vinylalcohol-vinylacetate) film doped with iodine. Other examples of such linear polarizers are disclosed in e.g. U.S. Pat. No. 6,049,428 and U.S. Pat. No. 6,025,897. Such polarizers have an extinction axis. Light polarized along the extinction axis is, at least substantially, extinguished whereas light polarized orthogonal thereto is, at least substantially, transmitted. As in practice transmission and extinction of polarized light is not complete, a figure of merit of a polarizer is its polarization contrast ratio which is defined as the ratio of light intensity of the polarization to be transmitted and the light intensity of the polarization to be extinguished. An ideal polarizer has an infinitely large polarization contrast ratio.

A disadvantage of these known polarizers is that the polarization contrast ratio depends on the angle at which light is incident on the polarizer. More in particular, the polarization contrast ratio is highest for light beams traveling in directions orthogonal to the extinction axis and becomes lower as the angle a light beam makes with the extinction axis increases.

It is an object of the invention, inter alia, to take away, or at least alleviate, the above-mentioned disadvantages and provide a polarizing arrangement which has a high polarization contrast ratio for a wide range of angles of incidence.

In accordance with the invention this object is achieved by a polarizing arrangement selectively transmissive for linear polarized light comprising a first linear polarizer having a first extinction axis and a second linear polarizer having a second extinction axis, wherein, in operation, a light beam traversing the first polarizer in a direction orthogonal to the first extinction axis traverses the second polarizer in a direction coincident with the second extinction axis.

The polarization contrast ratio of both the first and the second polarizer is dependent on the angle the light beam makes with the extinction axis, polarization being most efficient when the light beam is orthogonal to the extinction axis of the polarizer and becoming less efficient as the angle between the light beam and the extinction axis becomes smaller. In the extreme, if the angle between light beam and extinction axis is 0°, no (in practice minimal) extinction and hence no (in practice minimal) polarization takes places. The second extinction axis is arranged to extend in the direction of the light beam traveling in a direction orthogonal to first extinction axis. Consequently, a light beam travelling in that direction makes an angle of 90° with the first extinction axis, that is an angle where the first polarizer is most effective, and an angle of 0° with the second extinction axis, that is an angle where the second polarizer is not effective. As the angle the light beam makes with the first extinction axis becomes smaller and accordingly polarization becomes less effective, the angle that same light beam makes with the second extinction axis becomes larger and accordingly polarization due to the second polarizer becomes larger, the combined effect of the first and second polarizer being that the polarization contrast ratio remains more or less the same regardless the angle of incidence. Due to minor misalignments of the first polarizer relative to the second polarizer, a light beam which is orthogonal to the first extinction axis might not be exactly coincident with the second extinction axis. However it is sufficient that the light is substantially coincident with it, substantially meaning making an angle of 10° or less.

For many applications it is desirable that the first extinction axis is parallel or at least substantially parallel to a light entry and/or light exit surface of the polarizing arrangement where substantially parallel means the angle is less than about 10°. However, the first extinction axis (and consequently the second) may also be tilted with respect to such surface, where tilted means an angle of more than about 10°. Tilting may for example be of interest if the polarizing arrangement is combined with a waveguide for supplying light to the polarizing arrangement.

An extinction axis is an axis along which a linear polarization is extinguished (in the context of the invention, attenuation is synonymous for extinction) to a maximum extent compared to extinction along other axes. A light beam traveling in the direction of the extinction axis has no polarization along the extinction axis but only linear polarizations orthogonal thereto hence, in theory no, in practice minimal, extinction takes place for polarizations orthogonal to the extinction axis. In an ideal polarizer extinction is complete. However, in practice the material from which the polarizer is formed is not perfectly ordered. The degree of order is typically expressed in terms of an order parameter. The order parameter for liquid crystals is typically at least 0.7.

Extinction may be achieved by various means such as by means of light absorption (dichroic polarizers), light scattering (scattering polarizers), light reflection and refraction (reflective polarizers, polarizing beam splitters) and diffraction (holographic polarizers). Such polarizers are known in the art as such and may be suitably used in the context of the present invention. Wire grid polarizers, known in the art as such, may also be used.

In a preferred embodiment the first polarizer is a dichroic polarizer in which the dichroic colorant is planar uniaxially oriented in the direction of the first extinction axis. To avoid any doubt, in the context of the invention, dichroic means having an absorption of which the transition dipole moment is directionally dependent. Such polarizers have a high polarization contrast ratio and are available in a large variety of wavelength ranges including the visible range. The director of the planar uniaxial order is aligned with the first extinction axis.

In another preferred embodiment the second polarizer is a dichroic polarizer in which the dichroic colorant is homeotropically ordered in a direction coincident with the second extinction axis. Homeotropically ordered dichroic polarizers can be made using simple methods to obtain polarizers large surface area, in particular they are conveniently manufactured in the form of a layer. The second extinction axis and hence the director of the homeotropic order may be at least substantially perpendicular to a light entry and/or light exit surface of the second polarizer, at least substantially perpendicular meaning making an angle of less than about 10° or tilted with respect thereto, meaning making an angle of more than about 10°.

In a particular preferred embodiment, the first polarizer comprises a stretched polymeric material in which the ordered dichroic colorant is dispersed. Stretched polymeric dichroic polarizers combine a particularly high polarization contrast ratio with a particularly strong angular dependency.

The polarizing arrangement in accordance with the invention may also comprise a first and/or second polarizer comprising an ordered polymerized liquid crystal in which a dichroic colorant is dispersed.

In a preferred embodiment, the dichroic colorant of the first and the second polarizer are one and the same to match the wavelengths for which the first polarizer is active in a convenient manner to the wavelengths for which the second polarizer is active.

The polarizing arrangement may comprise separate first and second polarizers but in a particular suitable embodiment the first and second polarizer are individual parts of a composite body such as a laminate. The first and second may be in direct contact with each other or may be separated by means of optically active parts of the composite body.

In another particular embodiment, to achieve further integration, the first and second polarizers are integrally formed as a single part of a polarizing body.

Polarizers have many applications in diverse technical fields such as lighting, photography and glazing. A particular interesting application relates to displays, in particular liquid crystal displays. In a preferred embodiment the invention therefore relates to a display comprising a polarizing arrangement in accordance with the invention.

The invention also relates to a combination of a first and a second polarizer adapted for use in the polarizing arrangement of the invention. More in particular, a first such polarizer is a linear polarizer of a conventional type which has an extinction axis substantially parallel to a light entry and/or light exit surface thereof whereas the second polarizer is a dichroic polarizer in which a dichroic colorant is homeotropically ordered in a direction coincident with the second extinction axis. In a homeotropic polarizer, the director associated with the homeotropic order is substantially perpendicular to a light entry and/or light exit surface of the homeotropic polarizer.

The invention further relates to the use of a body comprising a dichroic colorant which is homeotropically ordered with respect to a major surface of the body as a polarizer. Such a homeotropic polarizer has many interesting applications, one such application being in an anti-reflective arrangement.

In a further aspect, the invention relates to an anti-reflective arrangement comprising a combination of a first and a second polarizer for use in a polarizing arrangement in accordance with the invention wherein the second polarizer has a second extinction axis and is a dichroic polarizer in which a dichroic colorant is homeotropically ordered in a direction coincident with the second extinction axis and the anti-reflective arrangement further comprises an optical retarder for converting linearly polarized light into circularly polarized light. Preferably, the second polarizer is arranged between the first polarizer and the optical retarder.

An anti-reflecting arrangement for reducing the reflectivity of a light reflective surface comprising a linear dichroic polarizer and an optical retarder for converting linear polarized light into circularly polarized light, a quarter wave retarder for short, is known in the art as such. Such anti-reflective arrangement has the disadvantage that the extent to which the reflectivity is reduced depends on the angle at which (ambient) light is incident on the arrangement. To compensate for this angular dependency it is known in the art to add a homeotropically ordered body, the director of which extends perpendicular to the direction of normal incidence on a light entry/and light exit surface of the retarder. By using the homeotropically ordered polarizer of the present invention, the angular dependency of the retarder and the first polarizer is compensated for at the same time resulting in an anti-reflecting arrangement achieving a high reduction of reflection for a wide range of incidence angles.

These and other aspects of the invention will be apparent from and elucidated with reference to the drawings and the embodiments described hereinafter.

In the drawings:

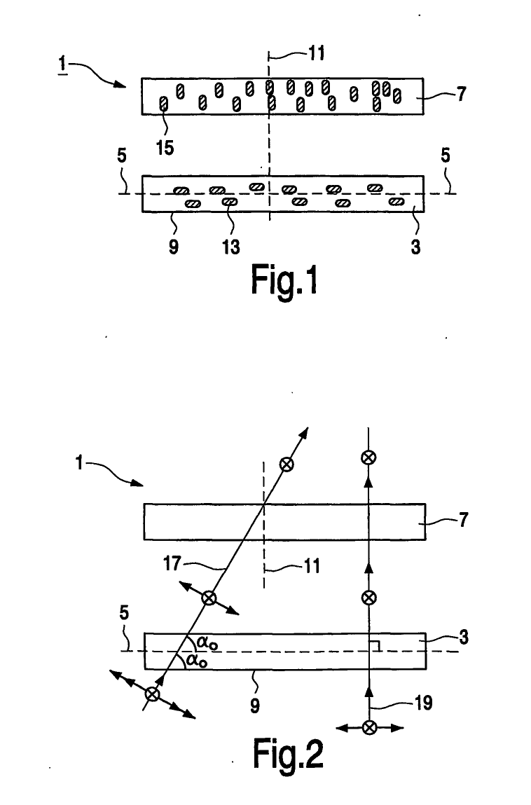

FIG. 1 shows, schematically, a cross-sectional view of an embodiment of a polarizing arrangement in accordance with the invention;

FIG. 2 shows, schematically, the polarization of a light beam incident at right and oblique angles on the polarizing arrangement of FIG. 1;

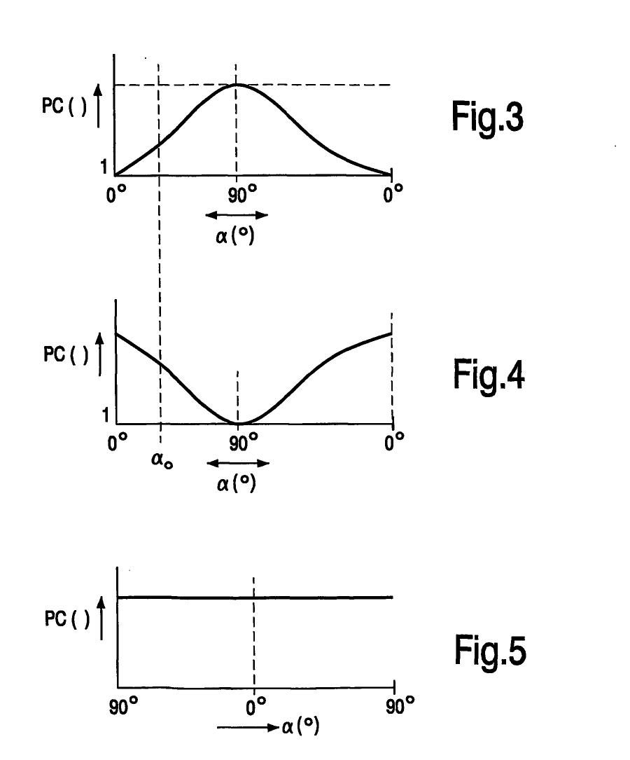

FIGS. 3 and 4, show schematically, the polarization contrast ratio PC (in dimensionless units) as a function of angle of incidence α (in degrees) of the first and second polarizer shown in FIG. 1 respectively;

FIG. 5, shows schematically, the polarization contrast ratio PC (in dimensionless units) as a function of angle of incidence α (in degrees) of the polarizing arrangement of FIG. 1;

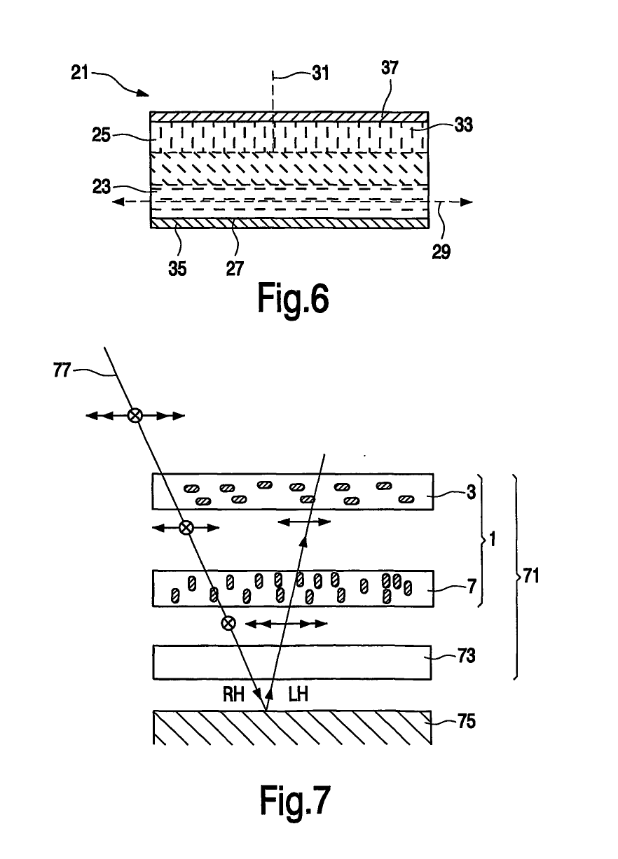

FIG. 6 shows, schematically, a cross-sectional view of a further embodiment of a polarizing arrangement in accordance with the invention; and

FIG. 7 shows, schematically, a cross-sectional view of an anti-reflective arrangement in accordance with the invention.

FIG. 1 shows, schematically, a cross-sectional view of an embodiment of a polarizing arrangement in accordance with the invention. The polarizing arrangement 1 comprises a first polarizer 3 and a second polarizer 7. The first polarizer 3 is a linear polarizer, that is a polarizer selectively transmissive for linear polarized light, having a first extinction axis 5. The first linear polarizer 3 has means 13 (which means will be further elucidated below) for at least partially extinguishing (attenuating) a polarization along the first extinction axis 5 and, at least partially, transmitting a polarization in a direction orthogonal to the first extinction axis 5. The second linear polarizer 7 has a second extinction axis 11 and means 15 for at least partially extinguishing a polarization along the second extinction axis 11 and at least partially transmitting a polarization in a direction orthogonal to the extinction axis 11. Along the extinction axes 5 and 11, a linear polarization is extinguished (in the context of the invention, attenuation is synonymous for extinction) to a maximum extent compared to extinction along other axes. A light beam traveling in the direction of an extinction axis has no polarization along such extinction axis but only linear polarizations orthogonal thereto, hence, in theory no, in practice minimal, extinction takes place for polarizations orthogonal to the extinction axis.

Referring to FIG. 2, the first and second polarizer are arranged such that a light beam traversing the first polarizer 3 in a direction orthogonal to the first extinction axis 5, such as the light beam 19, traverses the second polarizer in a direction coincident with the second extinction axis 11. In the present embodiment, the extinction axes 5 and 11 are orthogonal and intersect each other. This is by no means essential. If the polarizing component comprises optical components other than the first and second polarizer, more in particular components arranged between the first and second polarizer, the extinction axes 5 and 11 need not be orthogonal to or intersect one another. For example, if, after having traversed the first polarizer 3, the light beam is reflected off a mirror at an angle of 45° before traversing the second polarizer, the extinction axes are parallel in order for the light beam to traverse the second polarizer in a direction coincident with the second extinction axis.

FIGS. 3 and 4, show schematically, the polarization contrast ratio PC (in dimensionless units) as a function of angle of incidence α (in degrees) of the first and second polarizer shown in FIG. 1 respectively. Polarization contrast ratio PC is defined as the ratio of light intensity of the transmitted linear polarization and the light intensity of the extinguished polarization and the angle α is the angle of incidence of a light beam on the light entry surface 9 or, which amounts to the same thing in the present embodiment as the extinction axis 5 is parallel to the light entry surface 9, the angle between the light beam and the extinction axis 5.

The polarization contrast ratio PC of both the first and the second polarizer is dependent on the angle the light beam makes with its extinction axis, polarization being most efficient when the light beam is orthogonal to the extinction axis of the polarizer and becoming less efficient as the angle between the light beam and the extinction axis becomes smaller. In the extreme, if the angle between light beam and extinction axis is 0°, no or in practice minimal extinction and hence no polarization takes places. Referring to FIG. 2, the first and second polarizer are arranged relative to one another such that the second extinction axis 11 extends in the direction of a light beam, such as the light beam 19, traveling in a direction orthogonal to first extinction axis 5.

Consequently, referring to FIGS. 3 and 4, a light beam travelling in the direction α=90° makes an angle of 90° with the first extinction axis 5, that is an angle at which the first polarizer 3 is most effective, and an angle of 0° with the second extinction axis 11, that is an angle at which the second polarizer 7 is least efficient. For a light beam which is obliquely incident, such as the light beam 17 of FIG. 2, the angle of incidence cc is smaller and, accordingly, with reference to FIG. 3, polarization is less efficient. On the other hand, the angle that same light beam makes with the second extinction axis 11 is larger and, accordingly, with reference to FIG. 4, polarization due to the second polarizer 7 is more efficient, thus more or less compensating for the loss of polarization incurred by the first polarizer 3. FIG. 5 shows schematically the combined effect of the first and second polarizer, the effect being that the polarization contrast ratio remains at a high level for a wider range of incidence angles.

In the polarizing arrangement 1 the first extinction axis 5 is parallel to a light entry and/or light exit surface 9 of the polarizing arrangement. However, the first extinction axis (and consequently the second) may also be tilted with respect to such surface which may for example be of particular interest if the polarizing arrangement is combined with a waveguide for supplying light to the polarizing arrangement. However, in order to obtain first polarizers which are designed for normally incident light, the first extinction axis is preferably aligned parallel or at least substantially parallel to a light entry and/or light exit surface of the first polarizer. Similarly, in order to obtain second polarizers which are designed for normally incident light, the second extinction axis is preferably, at least substantially, perpendicular to a light entry and/or light exit surface of the second polarizer.

A variety of means for implementing the extinction axis of the first and second polarizer are available. For example, extinction may be achieved by means of light scattering in which case the polarizer may be referred to as a scattering polarizer. Such polarizers are known in the art as such, see eg WO 97/41484 and WO 01/90637. A scattering polarizer may comprise for example transparent optically anisotropic particles dispersed in an isotropic matrix the refractive index of the particles being along one axis and mismatched along another. If the particles contain switchable liquid crystal a switchable polarizer is obtained a particular embodiment of which is known in the art as a polymer dispersed liquid crystal.

An extinction axis may also be implemented by means of reflection, polarizers based on this principle are in known in the art as reflective polarizers, see eg the combination of a quarter wave retarder and cholesteric polarizer disclosed in EP 606940 and the polarizing laminate disclosed in U.S. Pat. No. 6,025,897.

Extinction may further be based on a combination of reflection and refraction, polarizers based on this principle being known in the art as polarizing beam splitters such as those disclosed in U.S. Pat. No. 5,845,035. Polarizers based on diffraction may also be used such as the holographic polarizer described in the International patent application with the number PCT/IB02/03719 (Applicant's file reference NL010683).

Also suitable are wire grid polarizers which obtain their polarizing ability from a grid of metal wires or metal lines with periodicities typically smaller than 500 nm in order to operate in visible wavelength region. Wire-grid polarizers are commercially available from Moxtek.

Well-known and preferred in the context of the present invention are polarizers where the extinction is achieved by means of light absorption. Such polarizers are known in the art as dichroic polarizers. Generally such polarizers comprise dichroic colorants the molecules (in case of a dye) or particles (in case of a pigment) of which are macroscopically aligned in the direction of the extinction axis such as schematically shown for the means 13 and 15 of FIG. 1. Suitable are, for example, the dichroic polarizers disclosed in U.S. Pat. No. 6,049,428.

Preferably, the first polarizer is a dichroic polarizer in which the dichroic colorant is planar uniaxially oriented in the direction of the first extinction axis. Such polarizers have a high polarization contrast ratio and are available in a large variety of wavelength ranges including the visible range and provide polarizers which polarize most efficiently for normally incident light.

The second polarizer may be a dichroic polarizer in which the dichroic colorant is homeotropically ordered in a direction coincident with the second extinction axis. Homeotropically ordered dichroic polarizers can be made using simple methods to obtain polarizers having large surface area, in particular they are conveniently manufactured in the form of a layer. In homeotropically ordered dichroic polarizers, the dichroic molecules are aligned perpendicular, at least substantially, to the light entry and/or light exit surface of the polarizer thus providing a polarizer which polarizes least efficiently for normally incident light and polarizes more efficiently when light is obliquely incident. The director of the homeotropic order may be also be tilted with respect to a light entry and/or light exit surface of the homeotropic polarizer. Layers comprising homeotropically ordered dichroic molecules which may be suitably used as second polarizer are known as such in the art. See e.g. EP 608924. Alternatively, a polymer dispersed liquid crystal wherein the liquid crystal in the particle domains are homeotropically aligned for example by applying a suitable voltage may also be used to obtain an extinction axis perpendicular to a light entry and/or exit surface of the second polarizer. Yet another example of a suitable second dichroic homeotropically ordered polarizer is a vertically aligned nematic liquid crystal (such liquid crystals being known in the art) provided with a dichroic dye of which the molecules are aligned with the liquid crystal molecules. Still further, self-assembled mono-layers of homeotropically ordered dye layers may be used. Such layers may be formed using Langmuir-Blodgett or micro-contact printing methods.

In a particular preferred embodiment, the first polarizer comprises a stretched polymeric material in which an ordered dichroic colorant is dispersed. Stretched polymeric dichroic polarizers combine a particularly high polarization contrast ratio with a particularly strong angular dependency. Stretched polymers are very suitable to obtain planar uniaxial order and less suitable to obtain homeotropic order. Examples of stretched polymers include stretched polyethylene, poly-ethylenenaphthalene (EN), polyvinylalcohol and polyethyleneterephthalate and other polymers such as those disclosed in U.S. Pat. No. 6,133,973. A preferred stretched polymer polarizer is a poly(co-vinylalcohol-vinylacetate) polarizer comprising iodine as dichroic colorant. A suitable stretched polymer scattering polarizer is disclosed in U.S. Pat. No. 5,825,543.

The polarizing arrangement in accordance with the invention may also comprise a first and/or second polarizer comprising an ordered polymerized liquid crystal in which dichroic colorant is dispersed. Polymerized liquid crystals with dichroic dyes are known in the art as such see eg EP442538 and EP 608924.

Particularly suitable dichroic polarizers are those comprising polymers obtained by (photo-)polymerizing (photo-)polymerizable and/or (photo-)cross-linkable liquid crystal compositions to obtain a uniaxially ordered polymer. Such polymers are known in the art per se, see eg WO 88/000227. Examples of polymerizable and/or crosslinkable liquid crystals are mesogenic substances provided with one or more polymerizable groups such as (meth)acrylate, vinylether, vinyl, oxetane or epoxide groups. A thiol-ene (system) may also be used. Cross-linkable liquid crystal compositions are particularly attractive if a polarizer is to serve as a substrate for the deposition of further layers as cross-linked polymers provide resistance in particular solvent resistance to the processing required for depositing the further layer.

The first and/or second polarizer may be patterned, such as a patterned polarizer including regions which are polarizing and regions which are non-polarizing. Such a patterned polarizer may be conveniently manufactured using photo-polymerizable liquid crystals.

The first and/or second polarizer may be optimized for a desired range of wavelengths. How optimization is to be done depends on the type of polarizer used. For example, in case of a dichroic polarizer the wavelengths for which the polarizer is active is selected by means of the absorption spectrum of the dichroic colorant. The first and/or second polarizer may be a narrow band polarizer covering for example only a part of the visible spectrum or a broad band polarizer covering for example the entire visible spectrum. Preferably, the dichroic colorant of the first and the second polarizer are one and the same to match the wavelengths for which the first polarizer is active manner to the wavelengths for which the second polarizer is active.

The first polarizer 3 and second polarizer 7 of FIG. 1 are provided in the form of layers or foils. The layers may be self-supporting or supported by means of a substrate or backing film. The foils may be rigid, flexible or foldable or wrappable. The polarizers may have other body shapes such as a wedge, a rod, a bar, a fiber, a prism, or trapezoid. The polarizers may have a relief structured surface to influence the characteristics of light beams exiting or entering the polarizing arrangement.

The polarizers of FIG. 1 are shown as separate distinct components. This is not essential, the first and second polarizer may also be joined so as to be part of a composite body such as a laminate if the polarizers are provided in the form of layers. The first and second polarizers may be in direct contact or may be intervened by other optical components, such as a layer of optical adhesive to secure the first to the second polarizer.

Referring to FIG. 6, to achieve further integration, the first and second polarizer may be integrated in a single body polarizing arrangement 21 comprising a first polarizing zone 23 and a second polarizing zone 25 separated by a non-polarization selective zone. The first polarizing zone 23 has an extinction axis 29 which is parallel to the light entry surface 27 and the second polarizing zone 25 has a second extinction axis 31 which is orthogonal to and intersects the extinction axis 29. The polarizing arrangement 21 operates in substantially the same manner as the polarizing arrangement of FIG. 1. The first and second polarizing zones may be formed from liquid crystals in which a dichroic colorant 33 is dispersed. Ordering the liquid crystals forces the dichroic colorant to become ordered as well. To obtain the order desired for the first and second polarizing zone, liquid crystals may be dispersed between an alignment layer 35 adapted for aligning liquid crystal in a planar uniaxially order and an alignment layer 37 adapted for aligning liquid crystal in a homeotropic order. Alignment layers capable of aligning liquid crystals in a planar uniaxial and homeotropic order are well known in the art. If use is made of (photo)-polymerizable liquid crystals, the order may be fixed by (photo)-polymerization.

The polarizing arrangement is of particular use in a display, particularly a liquid crystal display such as a passive or active matrix display or a reflective, transmissive or transflective display or a direct view or projection display. When provided with such an arrangement the contrast of the display is improved at off-normal viewing angles. The polarizing arrangement can be used to provide the polarized light to the liquid crystal cell but may also be used to analyze the polarization of light which has traversed the liquid crystal cell.

FIG. 7 shows, schematically, a cross-sectional view of an anti-reflective arrangement in accordance with the invention. The anti-reflective arrangement 71 comprises the polarizing arrangement 1 shown in FIG. 1 and an optical retarder 73 for converting linear to circularly polarized light. When positioned between a light source (not shown) and a light-reflective surface, such as the light-reflective surface 75, the anti-reflective arrangement 71 is able to reduce the reflections off the reflective surface. More specific, when an unpolarized light beam 77 is obliquely incident on the anti-reflective arrangement 71 the polarization parallel to the first extinction axis of the first polarizer 3 is extinguished to provide an attenuated light beam (the attenuation of the first polarizer 3 being indicated in FIG. 7 by the p-polarized light component with the four-headed arrow before and the two-headed arrow after passing the first polarizer 3). Then the attenuated light beam passes the second polarizer 7 after which the p-polarized component is substantially completely extinguished. The now s-polarized light beam is converted to a right-handed circularly polarized light beam RH by the retarder 73 which upon reflection off the reflective surface 75 is transformed, at least partially, into a left-handed circularly polarized light beam LH. The left-handed circularly polarized light beam (component) LH passes again the retarder 73 thus converting the left-handed circularly polarized light beam into a p-polarized light beam for which in the ideal case a retardation of a quarter λ is necessary. However, the actual retardation brought about by the retarder 73 depends on the angle at which the left-handed circularly polarized light beam is incident. The larger the angle, the larger the retardation provided by the retarder 73. Thus if the retarder 73 is designed to provide a quarter λ for normal incidence, it will provide elliptically polarized light for off-normal incidence. Being homeotropically ordered, the second polarizer 7 is birefringent. More particular, the refractive index of the second polarizer 7 for light traveling in directions normal to the light entry surface facing the retarder 73 is smaller than for directions orthogonal thereto. Hence the light beam is retarded to a different extent. The difference in retardation caused by the second polarizer 7 is such that the difference in retardation of the retarder 73 between normal and off-normal incidence is compensated for. As explained above with reference to FIG. 1 to 4, the second polarizer also functions as a polarizer for the obliquely incident light beam thus compensating for the angular dependence of the first polarizer 3. The second polarizer 7 therefore serves the dual purpose of compensating for the angular dependence of the retarder 73 and the first polarizer 3. In order to effectively compensate for the angular dependence of the retarder 73, the retardations of the retarder and second polarizer are selected such that Rᵣₑₜ(α)+Rₚₒₗ(α)=¼λ and Rᵣₑₜ(α=0°)+Rₚₒₗ(α=90°)=¼λ wherein Rᵣₑₜ(α) and Rₚₒₗ(α) is the retardation of the retarder 73 and the second polarizer 7 respectively at angle of incidence α. More in particular, if the angular dependence of the retardation of the retarder 73 is as is schematically shown in FIG. 3 with retardation R on the vertical axis instead of PC, effective compensation is achieved if the angular dependence of the retardation of the second polarizer 7 varies as is schematically shown in FIG. 4 with retardation R on the vertical axis instead of PC.

The anti-reflective arrangement in accordance with the invention may be used to reduce the reflectivity of any reflective surface but is most effective for a specularly reflective surface as such a surface inverts the handedness of circularly polarized light upon reflection. It is of particular use for the suppression of ambient light reflections. In an attractive embodiment, the anti-reflective arrangement is used in a display. In practice a display has one or more surfaces which reflect ambient light to a viewer which reduces the contrast of the display. If the anti-reflective arrangement is positioned in the display such that the light emitted by the display is generated on the light-reflective-surface side of the anti-reflective arrangement, ambient light is substantially completely absorbed while only half of the light emitted by the display is absorbed Such display has therefore an improved contrast under day light viewing conditions. Displays which may suitably comprise an anti-reflective arrangement in accordance with the invention include organic electroluminescent displays, liquid crystal displays, electrophoretic displays, cathode ray tubes and plasma displays.

1. A polarizing arrangement selectively transmissive for linear polarized light comprising a first linear polarizer having a first extinction axis and a second linear polarizer having a second extinction axis, wherein, in operation, a light beam traversing the first polarizer in a direction orthogonal to the first extinction axis traverses the second polarizer in a direction coincident with the second extinction axis.

2. A polarizing arrangement as claimed in claim 1 wherein the first extinction axis is parallel to a light entry and/or light exit surface of the polarizing arrangement.

3. A polarizing arrangement as claimed in claim 1 wherein the first polarizer is a dichroic polarizer in which a dichroic colorant is planar uniaxially oriented in the direction of the first extinction axis.

4. A polarizing arrangement as claimed in claim 1 wherein the second polarizer is a dichroic polarizer in which a dichroic colorant is homeotropically ordered in a direction coincident with the second extinction axis.

5. A polarizing arrangement as claimed in claim 3 wherein the first polarizer comprises a stretched polymeric material in which an ordered dichroic colorant is dispersed.

6. A polarizing arrangement as claimed in claim 1 wherein the first and/or second polarizer comprises an ordered polymerized liquid crystal in which a dichroic colorant is dispersed.

7. A polarizing arrangement as claimed in claim 3 wherein the dichroic colorant of the first and the second polarizer are one and the same.

8. A polarizing arrangement as claimed in claim 1 wherein the first and second polarizer are individual parts of a composite body.

9. A polarizing arrangement as claimed in claim 1 wherein the first and second polarizer are integrally formed as a single part of a polarizing body.

10. A display comprising a polarizing arrangement as claimed in claim 1.

11. A combination of a first and a second linear polarizer for use in a polarizing arrangement as claimed in claim 4.

12. Use of an optically anisotropic body comprising a dichroic colorant which is homeotropically ordered with respect to a major surface of the body as a polarizer.

13. An anti-reflective arrangement comprising a combination as claimed in claim 11 and an optical retarder for converting linearly polarized light into circularly polarized light.

14. An anti-reflective arrangement as claimed in claim 13 wherein the second polarizer is arranged between the first polarizer and the optical retarder.
